(19) United States
(12) Patent Application Publication
(10) Pub. No.: US 2026/0006286 A1
(43) Pub. Date: Jan. 1, 2026

(54) EQUIPPING MACHINE LEARNING MODELS WITH SOCIAL NETWORK KNOWLEDGE, VIDEO EDITING VIA FACTORIZED DIFFUSION DISTILLATION & EFFICIENT DEPTH STABILIZER FOR MIXED REALITY & AUGMENTED REALITY

(71) Applicant: Meta Platforms, Inc., Menlo Park, CA (US)

(72) Inventors: Hong Yan, Los Altos, CA (US); Adam Polyak, Tel Aviv (IL); Yaniv Nechemia Taigman, Raanana (IL); Devi Niru Parikh, San Francisco, CA (US); Rakesh Ranjan, Mountain View, CA (US); Hao Jiang, Bellevue, WA (US); Shelly Sheynin, Tel Aviv (IL); Uriel Singer, Harish (IL); Yuval Kirstain, Tel Aviv (IL); Jingqing Huang, Mountain View, CA (US); Amit Zohar, Tel Aviv (IL)

(21) Appl. No.: 19/213,924

(22) Filed: May 20, 2025

Related U.S. Application Data
(60) Provisional application No. 63/666,036, filed on Jun. 28, 2024.
(60) Provisional application No. 63/697,383, filed on Sep. 20, 2024.
(60) Provisional application No. 63/699,475, filed on Sep. 26, 2024.

(51) Int. Cl. H04N 21/431; G06N 20/00; G06T 11/60

(52) U.S. Cl. CPC H04N 21/4318; G06N 20/00; G06T 11/60

(57) ABSTRACT

Various systems, methods, and devices are described for utilizing artificial intelligence (AI) bot (e.g., a chatbot) to fetch or create content associated with a third-party platform based on an input associated with an electronic device. In an example, systems and methods of AI bot fetching or creating content may include receiving an input, via a user device. The input may be textual, audible, or any other suitable method. Based on the input, one or more content items may be fetched or created. The machine learning model may be utilized to determine context associated with the input. The machine leaning model may determine a number of content items associated with the input and data sources related to the retrieval generators. A result may be presented to a user, where the result may comprise the one or more content items determined.

### CROSS-REFENCE TO RELATED APPLICATIONS

This application claims the benefit of U.S. Provisional Application No. 63/666,036, filed Jun. 28, 2024, and U.S. Provisional Application No. 63/697,383, filed Sep. 20, 2024, and U.S. Provisional Application No. 63/699,475, filed Sep. 26, 2024, the entire content of which is incorporated herein by reference.

### TECHNOLOGICAL FIELD

The present disclosure generally relates to methods, apparatuses, and computer program products for generating or fetching content based on a input associated with a user.

### BACKGROUND

Electronic devices are constantly changing and evolving to provide users with flexibility and adaptability. Many electronic devices may provide methods for users to search the internet or generate content via applications, web pages, platforms, or the like for information of interest to the user. In some instances, an electronic device may employ or utilize a chatbot to provide a service or method to obtain wanted information of interest to a user. A chatbot may be a computer program that simulates human conversation with a user. In some examples, chatbots may utilize or employ one or more machine learning systems comprised of algorithms, features, machine learning models, or data sets that may optimize responses over time that accurately interpret user questions and match them to specific intents.

### BRIEF SUMMARY

Various systems, methods, and devices are described for utilizing artificial intelligence (AI) (e.g., a chatbot) to fetch or create (e.g., generate) content associated with a third-party platform based on an input, associated with an electronic device.

In various examples, systems and methods of AI fetching or creating (e.g., generating) content may include receiving an input, via a user device. The input may be textual, audible, or any other suitable method. Based on the input, one or more content items may be fetched or generated. The machine learning model may be utilized to determine context associated with the input. The machine learning system may include one or more generators. The retrieval generators may collect, store, or receive particular sets of information associated with one or more connections to a user profile.

The machine learning model may fetch or create (e.g., generate) content associated with the received input. The machine learning model may utilize a neural network to generate an association between one or more inputs, a contextual baseline of a conversation (e.g., a group of users chatting), historical inputs, information associated with one or more connections to a user profile, or any other suitable data. The machine learning model may provide a content item (e.g., text, images/photographs, audio, gifs, videos, or the like). The content item media may reflect the input provided by a user. In an example, the machine learning model may be trained based on statistical models to analyze vast amounts of data, learning patterns and connections between words, phrases, natural language patterns, and/or previously selected replies associated with a user(s). In an example, the machine learning model may utilize one or more retrieval generators to collect, store, or receive information associated with one or more connections to a user profile, or any other suitable information. In an example, the machine learning model may utilize one or more neural networks to develop associated between the received input and information fetched from the one or more retrieval generators, natural language patterns, previously received inputs, and/or context of a conversation. The machine learning model may facilitate providing the content item to a user(s) via a graphical user interface of a device.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates an example system, in accordance with an example of the present disclosure.

FIG. 2 illustrates an example retrieval generator, in accordance with an example of the present disclosure.

FIG. 3 illustrates an example method, in accordance with an example of the present disclosure.

FIG. 4 illustrates an example computing device, in accordance with the present disclosure.

FIG. 5 illustrates a machine learning and training model, in accordance with the present disclosure.

FIG. 6 illustrates an example video editing model text-guided video editing that enables various tasks.

FIG. 7 illustrates an example model architecture and alignment procedure.

FIG. 8 illustrates an example of text-guided video editing using a plug and play approach.

FIG. 9 illustrates an example method for video editing as disclosed herein.

FIG. 10 illustrates a machine learning and training model in accordance with various examples of the present disclosure.

FIG. 11 illustrates an example block diagram of a device.

FIG. 12 is a flow diagram illustrating a process for implementing an efficient depth stabilizer for MR and AR, according to some aspects of the subject technology.

FIG. 13 is a high-level block diagram illustrating a neural network architecture within which some aspects of the subject technology are implemented.

FIG. 14 is a high-level block diagram illustrating a network architecture within which some aspects of the subject technology are implemented.

FIG. 15 is a block diagram illustrating details of a system including an MR/AR headset of the subject technology, according to some embodiments.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the present invention will now be described more fully hereinafter with reference to the accompanying drawings, in which some, but not all examples of the invention are shown. Indeed, various examples of the invention may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received or stored in accordance with examples of the invention. Moreover, the term “exemplary”, as used herein, is not provided to convey any qualitative assessment, but instead merely to convey an illustration of an example. Thus, use of any such terms should not be taken to limit the spirit and scope of examples of the invention.

### A. Equipping Machine Learning Models With Social Network Knowledge

Many electronic devices may provide methods for users to search the internet or generate content via applications, web pages, platforms, or the like based on an input associated with a user. In some instances, an electronic device may employ or utilize a chatbot to provide a method to obtain the wanted information of interest associated with the input. Although a user may be able to use a chatbot to receive information associated with a received input, in many instances the chatbot may not be configured to reference or process information associated with a user account and one or more connections associated with the user account of a social media platform. One such problem chatbots may experience when generating or fetching an appropriate result associated with the input may be hallucinations. Hallucinations may be a situation where the machine learning model may make up a result that does not exist or is not necessarily relevant to the input received.

Some platforms, applications, or companies have utilized chatbots (artificial intelligence) to provide a method for users to interact, create, or fetch content items based an input associated with a user. However, current chatbots may utilize machine learning models that may be insufficient when a user may request information associated with a social media platform. There may be a need for a more convenient and precise machine learning model that may be utilized in chatbots. Disclosed herein are method, systems, or apparatuses that may provide an artificial intelligent platform in which artificial intelligence (AI) may be utilized to reference, fetch, or create (e.g., generate) content (e.g., images, videos, audio, or the like). The AI platform may utilize one or more retrieval generators that may be configured to store, receive, or collect information associated with a user profile and one or more connections associated with the user profile. The AI platform may employ large language models (LLMs) or machine learning models in combination with one or more retrieval generators to provide a more precise and convenient result associated with a received input. The AI platform may determine an association between an input, a user profile, or information associated with one or more connections associated with the user profile to generate a result that may be of interest to the user based on a determined relationship between the input and information associated with one or more connections associated with the user profile, via one or more retrieval generators.

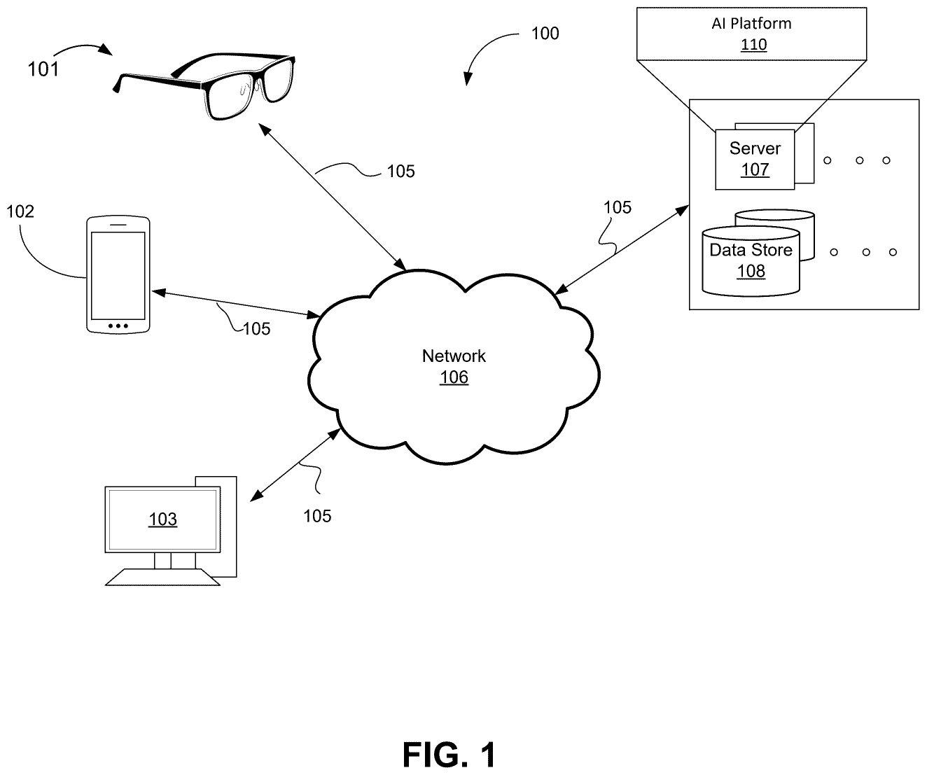

FIG. 1 illustrates an example AI system 100 that may implement an AI platform 110. The AI system 100 may be capable of facilitating communications among users or provisioning of content among users. AI system 100 may include one or more communication devices 101, 102, and 103 (also may be referred to as user devices), server 107, data store 108, or AI platform 110. As shown for simplicity, AI platform 110 may be located on server 107. It is contemplated that AI platform 110 may be located on or interact with one or more devices of AI system 100. It is contemplated that AI platform 110 may be a feature or native component of a third-party platform or device (e.g., device 102, 103). Additionally, AI system 100 may include any suitable network, such as, for example, network 106.

In an example, device 101, device 102, and device 103 may be associated with an individual (e.g., a user) that may interact or communicate with AI platform 110. AI platform 110 may be considered, or associated with, an application, a messaging platform, a social media platform, or the like. In some examples, one or more users may use one or more devices (e.g., device 101, 102, 103) to access, send data to, or receive data from AI platform 110 which may be located on server 107, device (e.g., device 101, 102, 103), or the like.

This disclosure contemplates any suitable network 106. As an example and not by way of limitation, one or more portions of network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. In some examples, network 106 may include one or more networks 106.

Links 105 may connect device 101, device 102, or device 103 to AI platform 110 to network 106, or to each other. This disclosure contemplates any suitable links 105. In particular examples, one or more links 105 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular examples, one or more links 105 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 105, or a combination of two or more such links 105. Links 105 need not necessarily be the same throughout network 106 or AI system 100. One or more first links 105 may differ in one or more respects from one or more second links 105.

Devices 101, 102, 103 may be an electronic device including hardware, software, or embedded logic components or a combination of two or more such components and capable of carrying out the appropriate functionalities implemented or supported by the devices 101, 102, 103. As an example and not by way of limitation, devices 101, 102, 103 may be a computer system such as for example, a desktop computer, notebook or laptop computer, netbook, a tablet computer (e.g., smart tablet), e-book reader, global positioning system (GPS) device, personal digital assistant (PDA), handheld electronic device, cellular telephone, smartphone, augmented/virtual reality device, other suitable electronic device, or any suitable combination thereof. This disclosure contemplates any suitable device(s) (e.g., devices 101, 102, 103). One or more of the devices 101, 102, 103 may enable a user to access network 106. One or more of the devices 101, 102, 103 may enable a user(s) to communicate with other users at other devices 101, 102, 103.

In particular examples, AI system 100 may include one or more servers 107. Each of the servers 107 may be a unitary server or a distributed server spanning multiple computers or multiple datacenters. Servers 107 may be of various types, such as, for example and without limitation, web server, news server, mail server, message server, advertising server, file server, application server, exchange server, database server, proxy server, another server suitable for performing functions or processes described herein, or any combination thereof. In particular examples, each of the servers 107 may include hardware, software, or embedded logic components or a combination of two or more such components for carrying out the appropriate functionalities implemented or supported by server 107.

In particular examples, AI system 100 may include one or more data stores 108. Data stores 108 may be used to store various types of information. In particular examples, the information stored in data stores 108 may be organized according to specific data structures. In particular examples, each of the data stores 108 may be a relational, columnar, correlation, or other suitable database. Although this disclosure describes or illustrates particular types of databases, this disclosure contemplates any suitable types of databases. Particular examples may provide interfaces that enable devices 101, 102, 103 or another system (e.g., a third-party system) to manage, retrieve, modify, add, or delete, the information stored in data store 108.

In particular examples, AI platform 110 may be a network-addressable computing system that may host an online search network. AI platform 110 may generate, store, receive, or send user information (also referred herein as user data) associated with a user, such as, for example, user-profile data (e.g., user online presence), geographical location, previous searches, interactions with content, or other suitable data related to the AI platform 110. AI platform 110 may be accessed by one or more components of AI system 100 directly and/or via network 106. As an example and not by way of limitation, device 101 may access AI platform 110 located on server 107 by using a web browser, feature of a third-party platform (e.g., function of a social media application, function of a AR application), or a native application on device 101 associated with AI platform 110 (e.g., a messaging application, a social media application, another suitable application, or any combination thereof) directly or via network 106.

In particular examples, AI platform 110 may store one or more user profiles associated with an online presence in one or more data stores 108. In particular examples, a user profile may include multiple nodes-which may include multiple user nodes (each corresponding to a particular user associated with a device 101, device 102, or device 103) or multiple concept nodes (each corresponding to a particular role or concept)—and multiple edges connecting the nodes. Users of the AI platform 110 may have the ability to communicate and interact with other users. In particular examples, users associated with a particular device (e.g., device 101) may join the AI platform 110 and then add connections (e.g., relationships) to a number of other users (e.g., device 102, device 103) constituting contacts or connections of AI platform 110 to whom they want to communicate with or be connected with. The added connections may be described herein as one or more connections to a user profile (e.g., one or more connections associated with a user profile). The one or more connections to the user profile may comprise relationships to one or more other users associated with one or more other user profiles. For example, the one or more connections to the user profile may comprise a first friend of a plurality of friends associated with a list of friends.

In some examples, user connections or communications may be monitored for machine learning purposes. In an example, server 107 of AI platform 110 may receive, record, or otherwise obtain information associated with communications or connections of users (e.g., device 101, device 102, or device 103). As such, the monitored connections or communications may be utilized for determining trends related to a user profile or one or more connections associated with the user profile. Herein, the term contact (e.g., a known user, co-worker, or club of friends) may refer to any other user of AI platform 110 in which there is indication of a connection or relationship.

In particular examples, AI platform 110 may provide users with the ability to take actions on various types of items. As an example, and not by way of limitation, the items may include groups to which a user may belong, messaging boards in which a user might be interested, question forums, interactions with images, stories, videos, comments under a post, or other suitable items. A user may interact with anything that is capable of being represented in AI platform 110. In particular examples, AI platform 110 may be capable of linking a variety of users. As an example, and not by way of limitation, AI platform 110 may enable users to interact with each other as well as receive media (e.g., video, audio, text, or the like, or any combination thereof) from their respective group (e.g., associated with a number of connections), wherein the group may refer to a chosen plurality of users that may be communicating or interacting through application programming interfaces (API) or other communication channels to each other.

In some examples, a device (e.g., device 101, device 102, device 103) associated with a user may perform the methods as disclosed herein with a AI bot as a second user, wherein the AI bot (e.g., chatbot) may foster communication and provide a content item referenced, fetched, or created (e.g., generated) based on a input associated with a user, wherein a machine learning model may fetch, reference, or create (e.g., generate) a content item associated with the input. In some examples, the AI bot may respond to the user with a result comprising a content item associated or related to the received input. The user and the AI bot may continue to foster communication and further develop ideas or reference information on the device (e.g., device 101, device 102, device 103) associated with the user or one or more connections associated with the user. In some examples, the AI bot may learn, via a machine learning model as disclosed herein, where a user profile associated with the user may be utilized to aid the AI bot in responding to the received input associated with the user.

Although FIG. 1 illustrates a particular arrangement of device 101, 102, 103, network 106, server 107, data store 108, or AI platform 110, among other things, this disclosure contemplates any suitable arrangement. The devices of AI system 100 may be physically or logically co-located with each other in whole or in part.

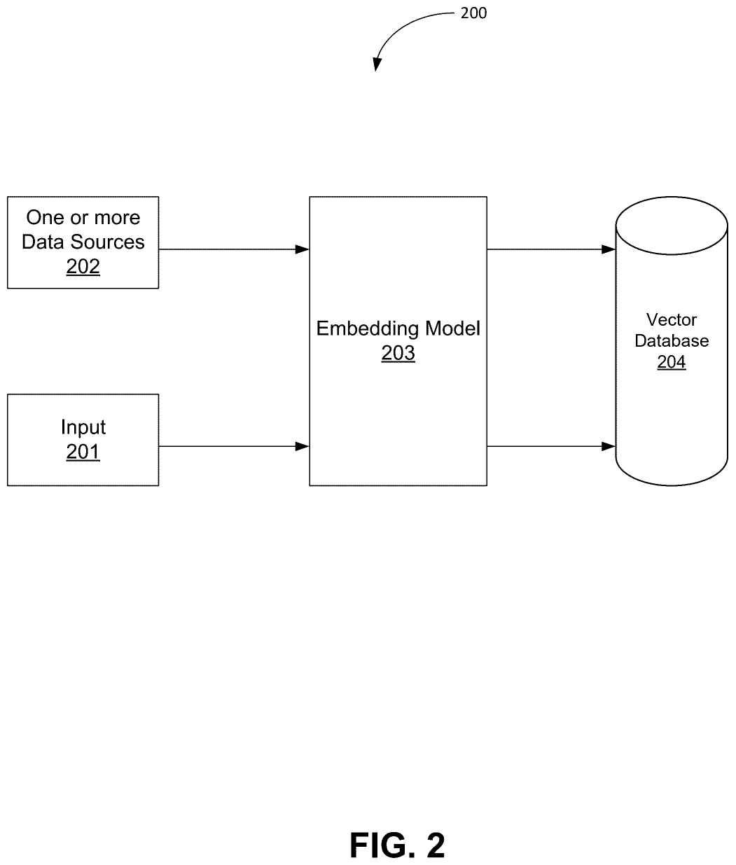

According to an embodiment of the disclosure, FIG. 2 illustrates an example retrieval generator 200. The retrieval generator 200 may be utilized to optimize the output of a machine learning model (e.g., a large language model). The retrieval generator 200 may reference an authoritative knowledge base outside of its training data sources before generating a response. LLMs may be trained on vast volumes of data and utilize billions of parameters to generate original output for tasks like answering questions, translating languages, completing sentences, or the like. As such, retrieval generator 200 may extend the capability of LLMs associated with the AI system 100 to specific domains, such as but not limiting to information associated with one or more of a user profile, one or more connections associated with the user profile, or any other suitable information associated with the user profile and the number of associated connections.

LLMs may take an input 201 and create a response based on information it was trained on, or what the LLMs may already know. Retrieval generators (e.g., retrieval generator 200) may employ an information retrieval component (e.g., associated with one or more data sources 202) that may utilize an input 201 to first pull information from one or more data sources 202. The data sources 202 may be one or more of information associated with a user profile, or one or more connections associated with the user profile. As an example, and by not by limitation, the data sources may be information associated with one or more of a number of contacts (e.g., friends) posts, information associated with contacts, posts contacts have interacted with, interests associated with contacts, or any other suitable information. Although, FIG. 2 may reference information associated with a number of contacts, it is contemplated that retrieval generator 200 may comprise data sources associated with one contact of a number of contacts associated with the user. As a result of retrieval generator 200, information may be fetched or referenced, such that the received input and relevant information, via retrieval generator 200, may be sent to a machine learning model (e.g., LLM) of AI platform 110. The machine learning model may then use the received input (e.g., input 201) and the relevant information (e.g., associated with one or more data sources 202) from the retrieval generator 200 to create (e.g., generate), or provide a result to the received input 201.

Retrieval generator 200 may utilize data associated with one or more social media platforms associated with AI platform 110. The data associated with retrieval generator 200 may be considered outside data, meaning the data associated with retrieval generator 200 may be separate from the training data associated with a machine learning model (e.g., LLM). The data associated with retrieval generator 200 may be associated with APIs, databases, or repositories associated with one or more social media platforms. In some examples, the data related to the input may be converted to a numerical value (e.g., a vector), via an embedding model 203, and stored in a database or data store (e.g., vector database 204) to be utilized by one or more machine learning models.

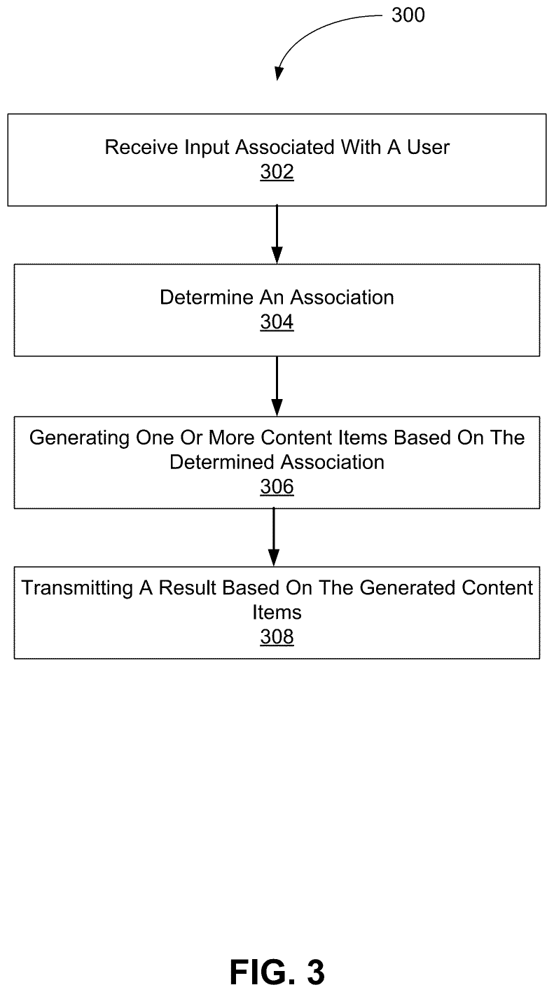

FIG. 3 illustrates an example method 300 for creating (e.g., generating), or fetching a content item, in example of the present disclosure. The method 300 may begin at step 302, where an input associated with a user may be received via AI platform 110. The input may be associated with a user (e.g., device 101, device 102, or device 103), wherein the input may be provided via graphical user interface of a device.

At step 304, a machine learning system, which may determine an association between embedded data and the received input. The machine learning system may include one or more retrieval generators (e.g., retrieval generator 200). The one or more retrieval generators 200 may be utilized to embed data (e.g., associated with a user profile and one or more connections to the user profile) based on the received input. In an example, one or more retrieval generators may fetch or generate data associated with one or more data sources associated with a user profile and one or more connections associated with the user profile. In an example, the one or more retrieval generators may store previously captured data associated with the user profile and one or more connections to the user profile. The data fetched, via the retrieval generators 200, may be utilized to train one or more machine learning models associated with a machine learning system. The data fetched may be of a set of particular data sources associated with a user profile, one or more connections associated with the user profile, or any combination thereof. In some examples, the set of particular data sources fetched may be associated with a determined context of the received input. In some examples, a machine learning model (e.g., a large language model) may be utilized to determine the context of the received input. Based on the determined context associated with the input, the machine learning system may be configured to determine an association between the embedded data (e.g., user engagement data, user data, data associated with a number of connections, or any combination thereof) and the received input.

The machine learning system may comprise a number of machine learning models. The machine learning system may utilize one or retrieval generators 200. The retrieval generator 200 may comprise a number of data sources associated with a user profile and one or more connections associated with the user profile. In an example, retrieval generator 200 may be configured to create data sources associated with the received input. In another example, retrieval generator 200 may comprise a number of predetermined data sources determined by a human operator associated with AI platform 110. The retrieval generator 200 may be configured to embed data associated with one or more data sources of interest (e.g., data source associated with context of the input), such that the machine learning system may utilize the data, wherein the embedded data associated with one or more retrieval generators 200 may be stored in a database.

At step 306, a content item may be fetched or created (e.g., generated), via a device (e.g., device 101, 102, 103), based on the association between the input and one or more embedded data associated with one or more retrieval generators 200. The created content item may utilize data directly from the machine learning system, one or more retrieval generators 200, user profile data, data associated with one or more connections to the user profile, data or content associated with a social media platform, or a combination thereof. The created content item may be a response to an input and the context associated with the input provided to an AI bot or chatbot associated AI platform 110.

The machine learning model of the machine learning system may be configured to convert the input to a numerical representation (e.g., a vector) and match or determine an association between the input and one or more embedded data sources (e.g., associated with the one or more retrieval generators 200). In some examples, data sources from one or more retrieval generators may be merged based on context associated with the input. In some examples, the machine learning model may be configured to determine a number of top results associated with the input in relation to the one or more retrieval generators 200. In some examples, the one or more retrieval generators 200 may perform a ranking associated with any number of data associated with each data source, such that the most relevant data to the input may be determined.

At step 308, a result may be provided to a user, via a device (e.g., device 101, device 102, or device 103), for example, through or by a third-party platform or AI platform 110 to a user's device. The result may be provided by a device (e.g., device 101, device 102, or device 103) in the form of a search response, advertisement, pop-up alert, a post on a user-feed, an image, a video, text, banner on a home screen, or any other form of content. In some examples, the result may be an alert or notification within an application, when interacting with a third-party platform (e.g., social media platform, business platform, banking platform, shopping platform, or the like). It may be appreciated that the method providing the result may utilize any of a variety of techniques, and may be customizable, as desired. The content of the result may be an accumulation of content items determined, fetched, or created (e.g., generated) at step 306, determined via the machine learning system. In an example, the result may be a single content item determined by the machine learning system of step 306.

For example, a user provides input to an AI bot such as, “birthday presents for my friend whose birthday is coming up.” As such, the machine learning system may retrieve data from one or more retrieval generators. The retrieval generators 200 may be associated with data sources such as posts liked by the friend (e.g., a connection of a number of connections) whose birthday is approaching, friend's information, groups associated with the friend whose birthday is approaching, friend's previous interactions on posts associated with products, or the like. The machine learning model may associate the input with a number of embedded data associated with the one or more retrieval generators 200. The machine learning model may determine a number of content items to be presented to the user. The machine learning model may be configured to provide a number of content items in a number of ways to the user (e.g., a slideshow of images, a video, audio, text, or the like). As such, the number of content items may be referred to as a result, wherein the result may be a number of content of items that are provided to a user via a graphical user interface associated with a user device (e.g., device 101, device 102, or device 103).

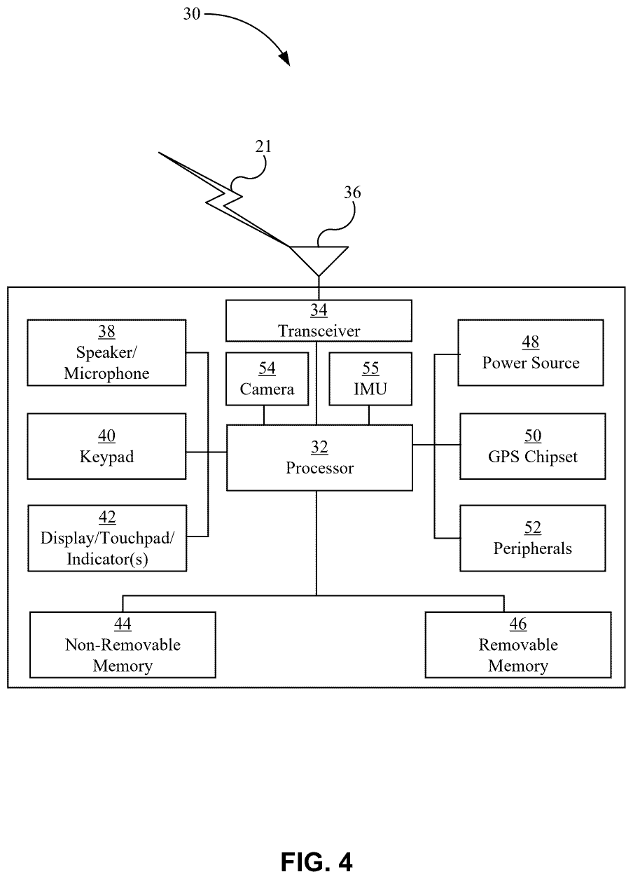

FIG. 4 illustrates a block diagram of an example hardware/software architecture of user equipment (UE) 30. As shown in FIG. 4, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54 and an inertial measurement unit (IMU) 55. In an example, the camera 54 is a smart camera configured to sense images appearing within one or more bounding boxes. The UE 30 may also include communication circuitry, such as a transceiver 34 and a transmit/receive element 36. It will be appreciated that the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an example, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another example, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

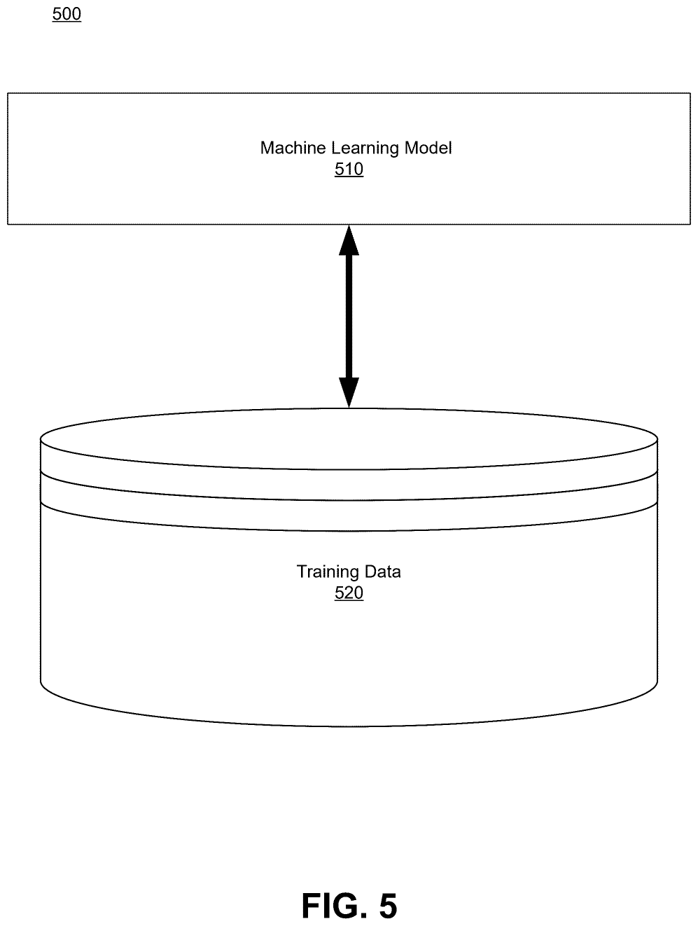

FIG. 5 illustrates a framework 500 that may be employed by the AI platform 110 associated with machine learning. The framework 500 may be hosted remotely. Alternatively, the framework 500 may reside within the AI system 100 as shown in FIG. 1 or be processed by a device (e.g., devices 101, 102, 103). The machine learning model 510 may be operably coupled with the stored training data in a database (e.g., data store 108). In some examples, the machine learning model 510 may be associated with other operations. The machine learning model 510 may be implemented by one or more machine learning models(s) (e.g., machine learning model of 204) or another device (e.g., server 107, or devices 101, 102, 103).

In another example, the training data 520 may include attributes of thousands of objects. For example, the object may be a smart phone, person, book, newspaper, sign, car, item and the like. Attributes may include but are not limited to the size, shape, orientation, position of the object, etc. The training data 520 employed by the machine learning model 510 may be fixed or updated periodically. Alternatively, the training data 520 may be updated in real-time based upon the evaluations performed by the machine learning model 510 in a non-training mode. This is illustrated by the double-sided arrow connecting the machine learning model 510 and stored training data 520.

In operation, the machine learning model 510 may evaluate associations between an input and a recommendation. For example, an input (e.g., a search, interaction with a content item, etc.) may be compared with respective attributes of stored training data 520 (e.g., prestored objects and/or dual encoder model).

Typically, such determinations may require a large quantity of manual annotation and/or brute force computer-based annotation to obtain the training data in a supervised training framework. However, aspects of the present disclosure, deploys a machine learning model that may utilize a dual encoder model that may be flexible, adaptive, automated, temporal, learns quickly and trainable. Manual operations or brute force device operations are unnecessary for the examples of the present disclosure due to the learning framework and dual neural network model aspects of the present disclosure. As such, this enables the user recommendations of the examples of the present disclosure to be flexible and scalable to billions of users, and their associated communication devices, on a global platform.

### B. Video Editing Via Factorized Diffusion Distillation

### TECHNOLOGICAL FIELD

Exemplary embodiments of this disclosure relate generally to methods, apparatuses, or computer program products for text-guided video editing.

### BACKGROUND

Text-guided video editing associated with artificial intelligence is an emerging field that leverages artificial intelligence technologies to manipulate and edit video content based on textual instructions or descriptions. This approach allows users to edit videos by describing their desired changes in natural language, rather than navigating complex traditional video editing software interfaces.

### SUMMARY

Disclosed herein are methods, systems, and apparatuses for text instructions to video editing platform that allows training of student models with unsupervised data. A video editing model may separately train an image editing adapter and a video generation adapter, and attach both to the same text-to-image model. The adapters may be aligned towards video by introducing an unsupervised distillation procedure, such as Factorized Diffusion Distillation (FDD). This procedure may distill knowledge from one or more teachers simultaneously, without any supervised data. The procedure may be used to teach video editing model to edit videos by jointly distilling knowledge to (i) edit each individual frame from the image editing adapter, and (ii) ensure temporal consistency among the edited frames using the video generation adapter. Different combinations of adapters may be aligned based on the disclosed approach.

Various systems, methods, and devices are described for utilizing artificial intelligence (AI) bot (e.g., a chatbot) to fetch or create content associated with a third-party platform based on an input associated with an electronic device. In an example, systems and methods of AI bot fetching or creating content may include receiving an input, via a user device. The input may be textual, audible, or any other suitable method. Based on the input, one or more content items may be fetched or created. The machine learning model may be utilized to determine context associated with the input. The machine leaning model may determine a number of content items associated with the input and data sources related to the retrieval generators. A result may be presented to a user, where the result may comprise the one or more content items determined.

### DESCRIPTION

Some approaches to video editing have faced significant challenges due to the scarcity of supervised video editing data. Many prior techniques have focused on training-free methods, but these have shown limitations in both performance and the range of editing capabilities offered. The present disclosure relates to systems and methods for text-guided video editing which may be via factorized diffusion distillation. More specifically, the disclosed techniques may enable training of a video editing model without using supervised video editing data by leveraging separate image editing and video generation capabilities.

The disclosed subject matter may decouple the expectations from a video editing model into the following distinct criteria that comprises: (i) editing each individual frame, and (ii) ensuring temporal consistency among the edited frames. Leveraging this insight, the disclosed techniques follow at least a two-phase process. In the first phase, two or more separate adapters may be trained on top of the same frozen text-to-image model, such as an image editing adapter and a video generation adapter. It is contemplated that additional adapters can be added, but two are provided for simplicity of the example. Then, by applying both adapters simultaneously, limited video editing capabilities may be enabled. In the second phase, unsupervised alignment method is introduced, Factorized Diffusion Distillation (FDD), that may significantly improve the video editing capabilities of the model of the first phase. FDD assumes a student model and one or more teacher models. The adapters may be employed as teachers, and for the student model, trainable low-rank adaptation (LoRA) weights may be used on top of the frozen text-to-image model and adapters. At each training iteration FDD may generate an edited video using the student. Then, it uses the generated video to provide supervision from two or more teachers, which may be done via Score Distillation Sampling (SDS) and adversarial losses.

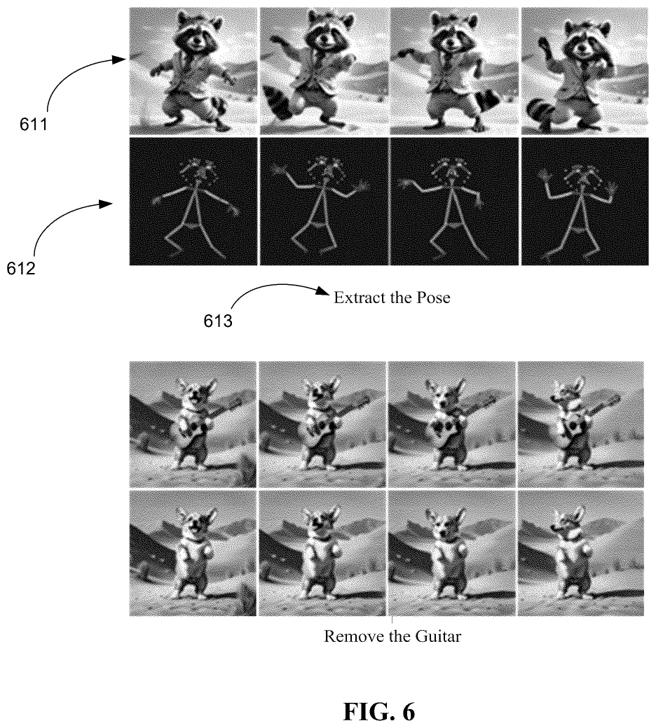

Experimentation has revealed that the resulting model, referred herein as video editing model, sets state-of-the-art results on the Text Guided Video Editing (TGVE) benchmark. Multiple aspects of the evaluation protocol may be improved that was set in TGVE. First, there may be an introduction of additional automatic metrics that are temporally aware. Second, the TGVE bench-mark may be expended (referred herein as TGVE+) to facilitate significant editing tasks, such as adding, removing, or changing the texture of objects in the video. A video editing model may exhibit state-of-the-art results when tasked with additional editing operations. FIG. 6 illustrates an example text-guided video editing that enables various tasks. The top row (e.g., input video 611) is a representation of the original video (multiple frames of the video) and the bottom row is the edit of the original video (e.g., edited video 612) implanted using the same or similar text (e.g., edit instructions 613), such as “extract the pose” or “remove the guitar,” as shown.

The disclosed subject matter may be applied to an arbitrary group of diffusion-based adapters. This was verified in practice by utilizing an approach to develop personalized image editing models by aligning an image editing adapter with different trainable low-rank adaptation (LoRA) adapters. In summary, the disclosed approach may use an image editing adapter and a video generation adapter and may align them to accommodate video editing using an unsupervised alignment procedure. The resulting video editing model may offer diverse video editing capabilities. Furthermore, the evaluation protocol may be extended for video editing by including additional automatic metrics and augment the TGVE benchmark with additional significant editing tasks. Experimentation has verified the approach can be used to align other adapters, and therefore may unlock new capabilities.

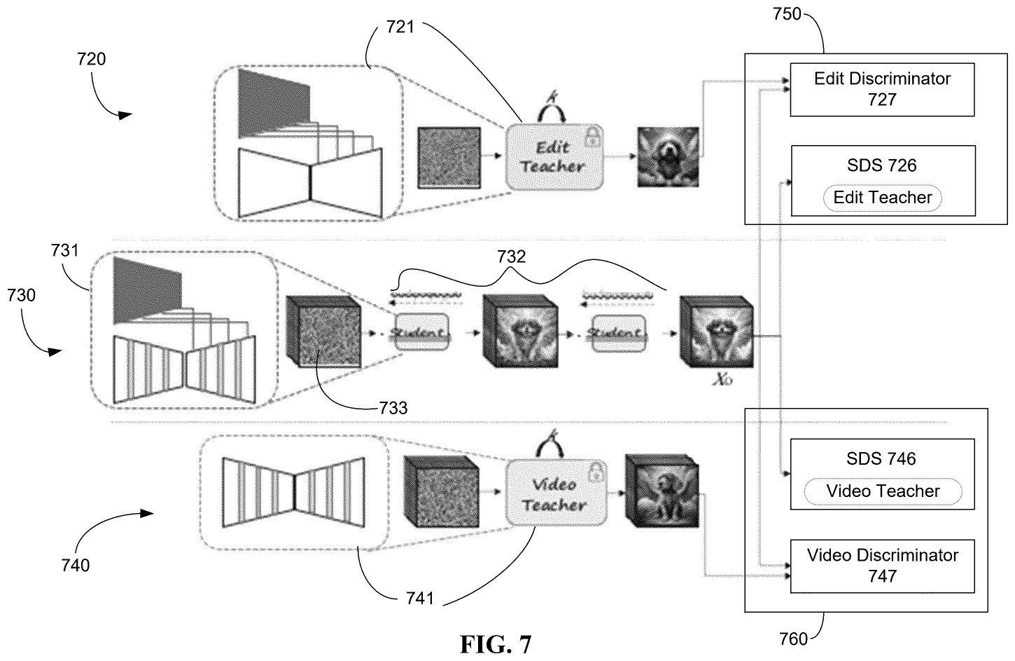

FIG. 7 illustrates an example model architecture and alignment procedure. An adapter for image editing (e.g., image editing adapter 721) and adapter for video generation (e.g., video generation adapter 741) may be trained on top of a shared text-to-image backbone. Student video editor adapter 731 may be generated by stacking adapters (e.g., image editing adapter 721 and video generation adapter 741) together on the shared backbone and aligning the two adapters.

Student video editor adapter 731 may be trained in multiple ways, such as (i) score distillation from each frozen teacher adapter (e.g., SDS 726 and SDS 746) and (ii) adversarial loss for each teacher (e.g., discriminator 727 and discriminator 747). SDS may be calculated on samples generated by video editing model 730 (e.g., the student model) from noise and the discriminators attempt to differentiate between samples generated by the teachers and the student. SDS 726 and SDS 746 may be based on analysis associated with image editing adapter 721 or video generation adapter 741, respectively. Note that image editing adapter 721 or video generation adapter 741 are frozen, while student video editor adapter is being trained. Therefore, the process at step 732 is iterative in training the student model. Adapters may be attached to a ML model (e.g., imaging editing adapter is attached to the text to image based model).

Below is a specific example of an approach with regard to how a dedicated adapter for each capability may be developed and how the disclosed architecture may combine adapters to enable video editing.

As described herein, the disclosed video editing model architecture may involve stacking multiple adapters, such as image editing adapter 721 and video generation adapter 741 on top of the same text-to-image backbone. A latent diffusion model (e.g., Emu) may be employed at the backbone model, and denote its weights with θ. Further herein is a description of the how the different components may be developed and combined to enable video editing.

For the video generation adapter 746, the disclosed techniques may make use of a text-to-video (T2V) model that consists of trained temporal layers on top of a frozen text-to-image model. The temporal layers are considered as the video adapter. The text-to-video model output can be denoted as \hat{x}_{ρ}(xₛ, s, cₒᵤₜ), where ρ=[θ, θ_{video}] are the text-to-image and video adapter weights, xₛ is a noisy video sample, s is the timestep, and cₒᵤₜ is the output video caption.

To create the image editing adapter 126, a ControlNet adapter or the like is trained, with parameters θ_{edit}, on a training dataset developed for image editing. The adapter may be initialized with copies of the down and middle blocks of the text-to-image model. During training, the text-to-image model may be conditioned on the output image caption, while using the input image and edit instruction as inputs to the ControlNet image editing adapter.

The output of the image editing model may be denoted as \hat{x}_{ψ}(xₛ, s, cₒᵤₜ, c_{instruct}, c_{img}), where ψ=[θ, θ_{edit}] are the text-to-image and image editing adapter weights, xₛ is a noisy image sample, s is the timestep, cₒᵤₜ is the output image caption, c_{instruct} is the textual edit instruction, and c_{img} is the input image to be edited.

To enable video editing capabilities, both adapters may be attached simultaneously to the text-to-image backbone. The goal may be to denoise a noisy edited video xₛ, using an input video c_{vid}, editing instruction c_{instruct}, and an output video caption cₒᵤₜ.

Notably, when attaching only the image editing adapter, the resulting function may process each frame independently. Therefore, each frame in the predicted video should be precise and faithful to the input frame and editing instruction, but may lack consistency with respect to the other edited frames. Similarly, when attaching only the video generation adapter, the resulting function may generate a temporally consistent video faithful to the output caption, but not necessarily faithful to the input video.

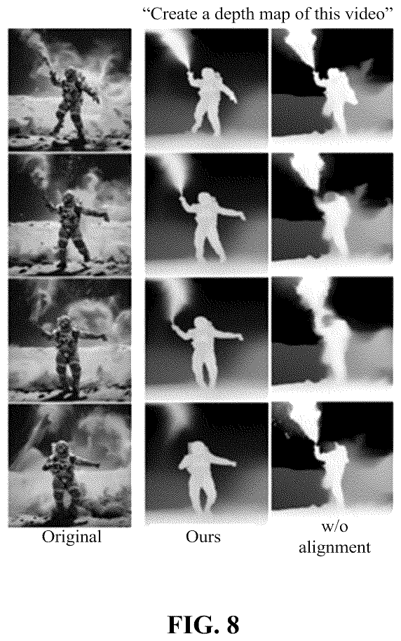

When combining both adapters with the shared text-to-image backbone, the resulting function may be \hat{x}_{η}(xₛ, s, cₒᵤₜ, c_{instruct}, c_{vid}), where η=[θ, θ_{edit}, θ_{video}]. This formulation may enable editing a video that is both temporally consistent and faithful to the input. However, in practice, this “plug-and-play” approach without alignment still includes significant artifacts, such as shown in FIG. 8.

As the necessary knowledge already exists in the adapters, a small alignment is expected to be sufficient. Therefore, the adapters are kept frozen and low-rank adaptation (LoRA) weights θ_{align} may be utilized over the text-to-image backbone. The final architecture becomes φ=[θ, θ_{edit}, θ_{video}, θ_{align}].

Factorized Diffusion Distillation is an example method to align the adapters, as shown in FIG. 7. To train θ_{align} and align the adapters without supervised video editing data, the disclosed techniques introduce a new unsupervised distillation procedure called Factorized Diffusion Distillation (FDD). In this procedure, both adapters are frozen, and their knowledge is jointly distilled into a video editing student.

Since the approach cannot assume supervised data, only a dataset for the inputs is collected. Each data point in this dataset consists of y=(cₒᵤₜ, c_{instruct}, c_{vid}), where cₒᵤₜ is an output video caption, c_{instruct} is the editing instruction, and c_{vid} is the input video.

In each iteration of FDD, the student model 130 first generates an edited video x0′ using a data point y for k diffusion steps. The loss may then be backpropagated through these diffusion steps (as further described herein).

Next, Score Distillation Sampling (SDS) loss may be applied using each teacher model. Noise ε and a time step t are sampled and used to noise x′₀ into x′ₜ. Each teacher may then be tasked to predict the noise from x′t independently. For a teacher E, the SDS loss is the difference between ε and the teacher's prediction:

$${ℒ}_{SDS} ( \hat{x} ) = \text{?} [ c ( t ) sg ( \hat{ϵ} ( {x}_{t}^{′} , t ) - ϵ ) {x}_{0}^{′} ] ,$$

$$\text{?} \text{indicates text missing or illegible when filed}$$

where c(t) is a weighting function, and sg indicates that the teachers are kept frozen. The metric may be averaged over student generations x′₀, sampled timesteps t and noise ε. Plugging in the edit and video teachers, the loss becomes:

$${ℒ}_{SDS - Edit} = {ℒ}_{SDS} ( {\hat{x}}_{ψ} ) , {ℒ}_{SDS - Video} = {ℒ}_{SDS} ( {\hat{x}}_{ρ} ) ,$$

For brevity, input conditions from \hat{x}_{φ}, \hat{x}_{ψ}, \hat{x}_{ρ} may be omitted. Each teacher provides feedback for a different criterion: the image editing adapter for editing faithfully and precisely, and the video generation adapter for temporal consistency.

To address the issue of blurry results often observed with distillation methods, an additional adversarial objective may be utilized for each teacher, similar to Adversarial Diffusion Distillation (ADD). Specifically, two discriminators are trained. The first, Dₑ, receives an input frame, instruction, and output frame and attempts to determine if the edit was performed by the image editing teacher or video editing student. The second, Dᵥ, may receive a video and caption, and attempts to determine if the video was generated by the video generation teacher or video editing student.

Following ADD, the hinge loss objective may be employed for adversarial training. The discriminator may minimize the following objectives:

$${ℒ}_{D - Edit} = {𝔼}_{{x}_{ψ}^{′}} [ max ( 0 , 1 - {D}_{e} ( {x}_{ψ}^{′} ) ) ] + {𝔼}_{{x}_{0}^{′}} [ max ( 0 , 1 + {D}_{e} ( {x}_{0}^{′} ) ) ] ,$$

$${ℒ}_{D - Video} = {𝔼}_{{x}_{ρ}^{′}} [ max ( 0 , 1 - {D}_{v} ( {x}_{ρ}^{′} ) ) ] + {𝔼}_{{x}_{0}^{′}} [ max ( 0 , 1 + {D}_{v} ( {x}_{0}^{′} ) ) ] ,$$

while the student minimizes:

$${ℒ}_{G - Edit} = - {𝔼}_{{x}_{0}^{′}} [ max ( 0 , 1 + {D}_{e} ( {x}_{0}^{′} ) ) ] ,$$

$${ℒ}_{G - Video} = - {𝔼}_{{x}_{0}^{′}} [ max ( 0 , 1 + {D}_{v} ( {x}_{0}^{′} ) ) ] ,$$

where xψ and xρ are samples generated from random noise by applying the image editing and video generation teachers for multiple forward diffusion steps using DDIM sampling.

The combined loss to train the student model may include:

$${ℒ}_{G - FDD} = α ( {ℒ}_{G - Edit} + {λℒ}_{SDS - Edit} ) + β ( {ℒ}_{G - Video} + {λℒ}_{SDS - Video} ) ,$$

and the discriminators may be trained with:

$${ℒ}_{D - FDD} = {αℒ}_{D - Edit} + {βℒ}_{D - Video} .$$

In practice, both α and β may be set to 0.5, and λ may be set to 2.5.

With reference to K-Bin Diffusion Sampling, to avoid train-test discrepancy due to different numbers of diffusion steps during training and inference, a K-Bin Diffusion Sampling strategy may be employed. The T diffusion steps may be divided into k evenly sized bins, each containing T/k steps. During each training generation iteration, a step may be randomly selected from its corresponding bin.

With reference to discriminator architecture, the base architecture of the discriminators is similar to that used in ADD. DINO (self-distillation with no labels, such as DINOv2) is utilized as a frozen feature network with trainable heads added to it. To add conditioning to the input image for Dₑ, an image projection may be used in addition to the text and noisy image projection, and the conditions may be combined with an additional attention layer. To support video conditioning for Dᵥ, a single temporal attention layer may be added over the projected features of DINO, applied per pixel.

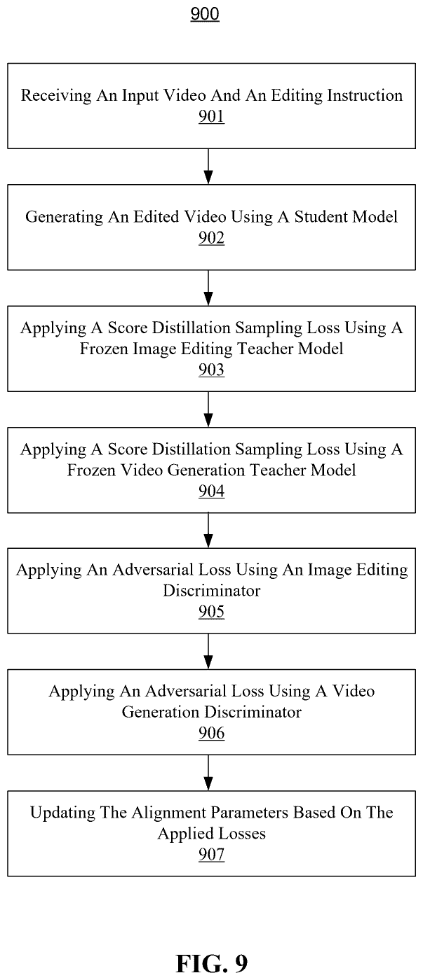

FIG. 9 illustrates an example method 900 for video editing as disclosed herein. At step 901, an input video 611 and an editing instruction 613 may be received.

At step 902, based on the input video 611 and the editing instruction 613, an edited video 612 using a student model 730 may be generated. The student model 730 may include a text-to-image backbone, an image editing adapter attached to the text-to-image backbone, a video generation adapter attached to the text-to-image backbone, and alignment parameters for aligning the image editing adapter and video generation adapter. The image editing adapter may be trained to edit individual frames and the video generation adapter may be trained to generate temporally consistent video frames. The alignment parameters may include low-rank adaptation weights. It also contemplated herein that diffusion timesteps may be divided into bins and timesteps may be randomly selected from the bins for training the student model 730.

At step 903, a score distillation sampling loss using a frozen image editing teacher model 726 may be applied. At step 904, a score distillation sampling loss using a frozen video generation teacher model 747 may be applied. The score distillation sampling losses of step 903 or step 904 may be calculated on samples generated by the student model from noise 733.

At step 905, an adversarial loss using an image editing discriminator 727 may be applied. At step 906, an adversarial loss using a video generation discriminator 747 may be applied. The image editing discriminator 727 or the video generation discriminator 747 may differentiate between samples generated by the video generation teacher model 746 and image editing teacher model 726 and samples generated by the student model 730.

At step 907, the alignment parameters may be updated based on the score distillation sampling loss using the frozen image editing teacher model 726, the score distillation sampling loss using the frozen video generation teacher model 746, the adversarial loss using the image editing discriminator 727, or the adversarial loss using the video generation discriminator 747. The propagation may train back into the model (e.g., model 730).

Experimental Evaluation: The effectiveness of the disclosed approach was assessed through a series of experiments that includes instruction-guided video editing. The video editing model may be benchmarked against multiple baselines using the Text-Guided Video Editing (TGVE) benchmark. Additionally, TGVE is expanded with new editing tasks, and the model is evaluated on this extended benchmark. To enhance the diversity of editing tasks, TGVE was extended to create TGVE+, adding three new editing operations: object removal, object addition, or texture alterations. This expanded benchmark may provide a more comprehensive evaluation of video editing capabilities. Ablation studies analyze the impact of different design choices in the approach. The capability of video editing model to perform zero-shot video editing on tasks not presented during alignment but within the editing adapter's knowledge domain was also explored. Lastly, a qualitative examination was conducted to verify the applicability of the approach to aligning other adapter combinations.

The experiments demonstrate the effectiveness of video editing model in performing a wide range of video editing tasks. The model shows particular strength in maintaining temporal consistency and accurately implementing complex editing instructions. The ablation studies reveal the importance of the design choices, particularly the impact of the alignment phase on the model's performance.

Video editing model exhibits significant improvement in tasks not explicitly trained during the alignment phase, such as object segmentation, pose extraction, sketch conversion, or depth map derivation. This suggests that the student model aligns with the knowledge base of the teacher model, even when exposed to only a subset of this knowledge during training.

Through qualitative analysis, it is confirmed that the approach can be applied to align various combinations of adapters. This flexibility may allow for expansion of the model's capabilities across different domains of video manipulation and generation.

The experiments demonstrate the effectiveness of video editing model in instruction-guided video editing across a diverse range of tasks. The model's ability to perform zero-shot editing on previously unseen tasks highlights the robustness of the alignment approach.

There were comparisons of video editing model results versus the baselines. Human raters preferred the video editing model over baselines by a significant margin. Moreover, when considering automatic metrics, the video editing model presents state-of-the-art results on objective metrics over most baselines.

Based on experimentation, FDD may be particularly adept at aligning pre-trained adapters. In addition, FDD may be preferred when combining adapters trained separately for different tasks. Employing the adversarial term alone is sufficient to achieve some level of alignment. Experimentation has found that after alignment, the edits may become more consistent with the reference style and subject.

The lack of supervised video editing data poses a major challenge in training precise and diverse video editing models. A common strategy to address this challenge is via training-free solutions. Initial work proposed the use of Stochastic Differential Editing. This approach performs image editing by adding noise to the input image and then denoising it while conditioning the model on a caption that describes the edited image. Several video foundation models, such as Lumiere and SORA, showcased examples in which they utilize SDEdit for video editing. While this approach can preserve the general structure of the input video, adding noise to the input video results in the loss of significant information, such as subject identity and textures. Hence, SDEdit may work when attempting to change a general style of an image, but by design, it is unsuitable for precise editing.

A more dominant approach is to inject information about the input or generated video from key frames via cross-attention interactions. Another strategy is to extract features that should persist in the edited video, like depth maps or optical flow, and train the model to denoise the original video while using them. Then, during inference time, one can predict an edited video while using the extracted features to ensure faithfulness to the structure or motion of the input video. The main weakness of this strategy is that the extracted features may lack information that should persist (e.g., pixels of a region that should remain intact) or hold information that should be altered (e.g., if the editing operation requires adding new motion to the video). Consequently, the edited videos may still suffer from unfaithfulness to the input video or editing operation.

To improve faithfulness to the input video at the cost of latency, some works invert the input video using the input caption. Then, they generate a new video while using the inverted noise and a caption that described the output video. Another work adapts the general strategy of InstructPix2Pix to video editing, which allows them to generate and train a video editing model using synthetic data. While this approach seems to be effective, recent work in image editing shows that Prompt-to-Prompt can yield sub-optimal results for various editing operations.

The disclosed subject matter deviates from prior work. Instead, distinct video editing capabilities may be distilled from an image editing teacher and a video generation teacher. Similarly to the Adversarial Diffusion Distillation (ADD) loss, the disclosed approach involves combining a Score Distillation Sampling loss and an adversarial loss. However, it significantly differs from ADD. First, the disclosed method may be unsupervised, and thus may generate data that is used for supervision rather than utilizing a supervised dataset. Second, distillation may be used to learn a novel capability, rather than reduce the number of required diffusion steps. Third, this capability may be learned by factorizing the distillation process or leveraging more than one teacher model in the process.

Methods, systems, and apparatuses with regard to video editing via factorized diffusion distillation are disclosed herein. A method, system, or apparatus may provide for generating an edited video using a student model; applying Score Distillation Sampling (SDS) loss using teacher models, including an image editing teacher and a video generation teacher; applying an adversarial objective for each of the teacher models; and training the student model using a combined loss from the SDS and adversarial objectives. The student model may include low-rank adaptation (LoRA) weights over a text-to-image backbone model. The teacher models may include an image editing adapter and a video generation adapter trained on top of the text-to-image backbone model. The SDS loss may involve sampling noise and a time step, noising the generated edited video, and tasking each teacher model to predict the noise independently. The adversarial objective may involve training two discriminators, one for distinguishing edits performed by the image editing teacher or video editing student, and another for distinguishing videos generated by the video generation teacher or video editing student. The method may further include using a k-bin diffusion sampling strategy to avoid train-test discrepancy. All combinations (including the removal or addition of steps) in this paragraph are contemplated in a manner that is consistent with the other portions of the detailed description.

A method for video editing, comprising: receiving an input video and an editing instruction; generating an edited video using a student model, wherein the student model comprises a text-to-image backbone model, an image editing adapter, a video generation adapter, and alignment weights; applying a score distillation sampling loss using an image editing teacher model and a video generation teacher model; applying an adversarial loss using an image editing discriminator and a video generation discriminator; and outputting the edited video. The image editing adapter and video generation adapter may be trained separately and then frozen when training the alignment weights. The method may include generating the edited video comprises applying k diffusion steps, and wherein k timesteps are randomly selected from k evenly sized bins of diffusion steps. The adversarial loss may include a hinge loss. The method may include dividing T diffusion steps into k evenly sized bins; and randomly selecting a timestep from each bin during training. All combinations (including the removal or addition of steps) in this paragraph and previous paragraphs are contemplated in a manner that is consistent with the other portions of the detailed description.

A method, system, or apparatus for video editing may include receiving an input video and an editing instruction; generating an edited video using a student model, wherein the student model comprises: a text-to-image backbone; an image editing adapter attached to the text-to-image backbone; a video generation adapter attached to the text-to-image backbone; and alignment parameters for aligning the image editing adapter and video generation adapter; applying a score distillation sampling loss using a frozen image editing teacher model; applying a score distillation sampling loss using a frozen video generation teacher model; applying an adversarial loss using an image editing discriminator; applying an adversarial loss using a video generation discriminator; and updating the alignment parameters based on the applied losses (e.g., image/video score distillation sampling loss or adversarial loss). The image editing adapter may be trained to edit individual frames and the video generation adapter may be trained to generate temporally consistent video frames. The score distillation sampling losses may be calculated on samples generated by the student model from noise. The discriminators may attempt to differentiate between samples generated by the teacher models and samples generated by the student model. The alignment parameters may comprise low-rank adaptation weights. All combinations (including the removal or addition of steps) in this paragraph and previous paragraphs are contemplated in a manner that is consistent with the other portions of the detailed description.

The method, system, or apparatus may further include dividing diffusion timesteps into bins; randomly selecting timesteps from the bins for training the student model. A system for video editing may comprise: a processor; and a memory storing instructions that, when executed by the processor, cause the system to: receive an input video and an editing instruction; generate an edited video using a student model comprising aligned image editing and video generation adapters; apply score distillation sampling losses using frozen image editing and video generation teacher models; apply adversarial losses using image editing and video generation discriminators; and update alignment parameters of the student model based on the applied losses. The student model may comprise a text-to-image backbone with the image editing and video generation adapters attached. The alignment parameters may comprise low-rank adaptation weights for aligning the image editing and video generation adapters. All combinations (including the removal or addition of steps) in this paragraph and previous paragraphs are contemplated in a manner that is consistent with the other portions of the detailed description.

A method for simultaneously distilling knowledge from multiple teacher models to a student network for video editing may comprise: training a first adapter for image editing using a first teacher model; training a second adapter for video generation using a second teacher model; aligning the first adapter and the second adapter on a shared text-to-image backbone to form a student network; generating edited video frames by distilling knowledge from the first teacher model to the student network using score distillation; ensuring temporal consistency among the edited frames by distilling knowledge from the second teacher model to the student network using an adversarial loss; combining additional adapters with the student network to unlock further capabilities. The score distillation may be applied to samples generated from noise by the student network. The adversarial loss may be calculated by discriminators attempting to differentiate between samples generated by the teacher models and the student network. The first adapter and the second adapter may be aligned by stacking both adapters together on the shared text-to-image backbone. The method may further comprise training the student network with additional combinations of adapters to expand the range of video editing capabilities. All combinations (including the removal or addition of steps) in this paragraph and previous paragraphs are contemplated in a manner that is consistent with the other portions of the detailed description.

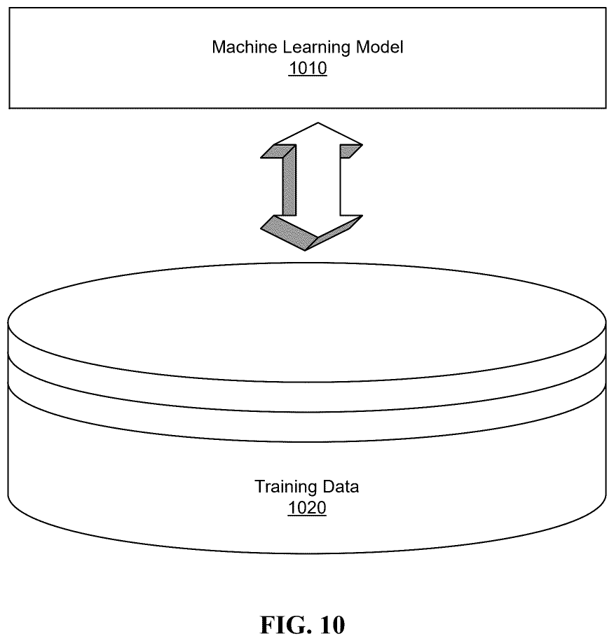

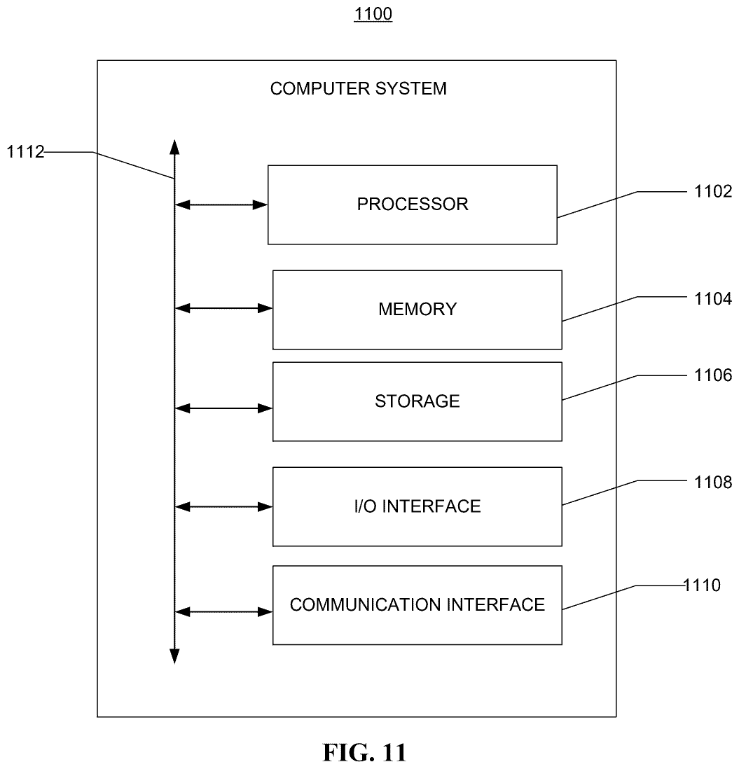

FIG. 10 illustrates a framework 1000 employed by a software application (e.g., computer code, a computer program) for text based video editing, in accordance with aspects discussed herein. The framework 1000 may be hosted remotely. Alternatively, framework 1000 may reside within a video editing model may be processed by the computing system 1100 shown in FIG. 11. Machine learning model 1010 may be operably coupled with the stored training data 1020 in a database. Machine learning (ML) and AI are generally used interchangeably herein.

In an example, the training data 1020 may include attributes of thousands of objects. For example, the object(s) may be identified or associated with user profiles, posts, photographs/images, videos, augmented reality data, sensor data (e.g., capacitive based sensors, magnetic based sensors, resistive based sensors, pressure based sensors, or audio based sensors), or the like. The training data 1020 employed by machine learning model 1010 may be fixed or updated periodically. Alternatively, training data 1020 may be updated in real-time or near real-time based upon the evaluations performed by machine learning model 1010 in a non-training mode.

In operation, the machine learning model 1010 may evaluate attributes of images, audio, videos, capacitance, resistance, or other information obtained by hardware (e.g., sensors, peripherals, etc.). For example, aspects of a user profile, posts, images, resistance, capacitance, audio, pressures, size, shape, orientation, position of an object and the like may be ingested and analyzed. The attributes of any of the above may then be compared with respective attributes of stored training data 1020 (e.g., prestored objects). The likelihood of similarity between each of the obtained attributes and the stored training data 1020 (e.g., prestored objects) may be given a determined confidence score. In one example, if the confidence score exceeds a predetermined threshold, the attribute is included in an instruction that is ultimately communicated, which may be to a user via a user interface of a computing device (e.g., computing system 1100). The sensitivity of sharing more or less attributes may be customized based upon the needs of the particular device.

FIG. 11 illustrates an example computer system 1100. One or more computer systems 1100 perform one or more steps of one or more methods described or illustrated herein. In particular embodiments, one or more computer systems 1100 provide functionality described or illustrated herein. In examples, software running on one or more computer systems 1100 performs one or more steps of one or more methods described or illustrated herein or provides functionality described or illustrated herein. Examples include one or more portions of one or more computer systems 1100. Herein, reference to a computer system may encompass a computing device, and vice versa, where appropriate. Moreover, reference to a computer system may encompass one or more computer systems, where appropriate.

The computer system 1100 includes a processor 1102 and memory 1104. The memory 1104 stores instructions that, when executed by the processor 1102, cause the computer system 1100 to implement the video editing functionality described herein. The computer system 1100 may be communicatively connected with a display for presenting edited video output 612.

This disclosure contemplates any suitable number of computer systems 1100. This disclosure contemplates computer system 1100 taking any suitable physical form. As example and not by way of limitation, computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein. As an example, and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

In examples, computer system 1100 includes a processor 1102, memory 1104, storage 1106, an input/output (I/O) interface 1108, a communication interface 1110, and a bus 1112. Although this disclosure describes and illustrates a particular computer system having a particular number of particular components in a particular arrangement, this disclosure contemplates any suitable computer system having any suitable number of any suitable components in any suitable arrangement.

In examples, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage 1106; decode and execute them; and then write one or more results to an internal register, an internal cache, memory 1104, or storage 1106. In particular embodiments, processor 1102 may include one or more internal caches for data, instructions, or addresses. This disclosure contemplates processor 1102 including any suitable number of any suitable internal caches, where appropriate. As an example, and not by way of limitation, processor 1102 may include one or more instruction caches, one or more data caches, and one or more translation lookaside buffers (TLBs). Instructions in the instruction caches may be copies of instructions in memory 1104 or storage 1106, and the instruction caches may speed up retrieval of those instructions by processor 1102. Data in the data caches may be copies of data in memory 1104 or storage 1106 for instructions executing at processor 1102 to operate on; the results of previous instructions executed at processor 1102 for access by subsequent instructions executing at processor 1102 or for writing to memory 1104 or storage 1106; or other suitable data. The data caches may speed up read or write operations by processor 1102. The TLBs may speed up virtual-address translation for processor 1102. In particular embodiments, processor 1102 may include one or more internal registers for data, instructions, or addresses. This disclosure contemplates processor 1102 including any suitable number of any suitable internal registers, where appropriate. Where appropriate, processor 1102 may include one or more arithmetic logic units (ALUs); be a multi-core processor; or include one or more processors 1102. Although this disclosure describes and illustrates a particular processor, this disclosure contemplates any suitable processor.

In examples, memory 1104 includes main memory for storing instructions for processor 1102 to execute or data for processor 1102 to operate on. As an example, and not by way of limitation, computer system 1100 may load instructions from storage 1106 or another source (such as, for example, another computer system 1100) to memory 1104. Processor 1102 may then load the instructions from memory 1104 to an internal register or internal cache. To execute the instructions, processor 1102 may retrieve the instructions from the internal register or internal cache and decode them. During or after execution of the instructions, processor 1102 may write one or more results (which may be intermediate or final results) to the internal register or internal cache. Processor 1102 may then write one or more of those results to memory 1104. In particular embodiments, processor 1102 executes only instructions in one or more internal registers or internal caches or in memory 1104 (as opposed to storage 1106 or elsewhere) and operates only on data in one or more internal registers or internal caches or in memory 1104 (as opposed to storage 1106 or elsewhere). One or more memory buses (which may each include an address bus and a data bus) may couple processor 1102 to memory 1104. Bus 1112 may include one or more memory buses, as described below. In examples, one or more memory management units (MMUs) reside between processor 1102 and memory 1104 and facilitate accesses to memory 1104 requested by processor 1102. In particular embodiments, memory 1104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory, this disclosure contemplates any suitable memory.

In examples, storage 1106 includes mass storage for data or instructions. As an example, and not by way of limitation, storage 1106 may include a hard disk drive (HDD), a floppy disk drive, flash memory, an optical disc, a magneto-optical disc, magnetic tape, or a Universal Serial Bus (USB) drive or a combination of two or more of these. Storage 1106 may include removable or non-removable (or fixed) media, where appropriate. Storage 1106 may be internal or external to computer system 1100, where appropriate. In examples, storage 1106 is non-volatile, solid-state memory. In particular embodiments, storage 1106 includes read-only memory (ROM). Where appropriate, this ROM may be mask-programmed ROM, programmable ROM (PROM), crasable PROM (EPROM), electrically erasable PROM (EEPROM), electrically alterable ROM (EAROM), or flash memory or a combination of two or more of these. This disclosure contemplates mass storage 1106 taking any suitable physical form. Storage 1106 may include one or more storage control units facilitating communication between processor 1102 and storage 1106, where appropriate. Where appropriate, storage 1106 may include one or more storages 1106. Although this disclosure describes and illustrates particular storage, this disclosure contemplates any suitable storage.

In examples, I/O interface 1108 includes hardware, software, or both, providing one or more interfaces for communication between computer system 1100 and one or more I/O devices. Computer system 1100 may include one or more of these I/O devices, where appropriate. One or more of these I/O devices may enable communication between a person and computer system 1100. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1108 for them. Where appropriate, I/O interface 1108 may include one or more device or software drivers enabling processor 1102 to drive one or more of these I/O devices. I/O interface 1108 may include one or more I/O interfaces 1108, where appropriate. Although this disclosure describes and illustrates a particular I/O interface, this disclosure contemplates any suitable I/O interface.

In examples, communication interface 1110 includes hardware, software, or both providing one or more interfaces for communication (such as, for example, packet-based communication) between computer system 1100 and one or more other computer systems 1100 or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1110 for it. As an example, and not by way of limitation, computer system 1100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1100 may include any suitable communication interface 1110 for any of these networks, where appropriate. Communication interface 1110 may include one or more communication interfaces 1110, where appropriate. Although this disclosure describes and illustrates a particular communication interface, this disclosure contemplates any suitable communication interface.

In particular embodiments, bus 1112 includes hardware, software, or both coupling components of computer system 1100 to each other. As an example and not by way of limitation, bus 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1112 may include one or more buses 1112, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

While the disclosed systems have been described in connection with the various examples of the various figures, it is to be understood that other similar implementations may be used or modifications and additions may be made to the described examples of a robotic skin or AI robotics platform, among other things as disclosed herein. For example, one skilled in the art will recognize that robotic skin or AI robotics platform, among other things as disclosed herein in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure-robotic skin or AI robotics platform—as illustrated in the Figures, specific terminology is employed for the sake of clarity. The claimed subject matter, however, is not intended to be limited to the specific terminology so selected.

C. Efficient Depth Stabilizer For Mixed Reality And Augmented Reality

### TECHNICAL FIELD

The present disclosure generally relates to depth estimation, and more particularly, to an efficient depth stabilizer for mixed reality (MR) and augmented reality (AR).

### BACKGROUND

Depth estimation is a fundamental task for AR and MR applications. It is the basis for features such as three-dimensional (3D) reconstruction, passthrough, occlusion, and smart guardian. One key requirement for depth estimation is temporal consistency. Traditional deep models are too complex to run in the MR/AR headset. There are no available light-weight models that can achieve the desired results.

### SUMMARY

The subject disclosure is directed to an efficient depth stabilizer for MR and AR. The disclosed technology relates to an efficient deep model to stabilize the depth prediction in AR/MR applications.

### DESCRIPTION

Some aspects of the subject disclosure are directed to an efficient depth stabilizer for MR and AR. The disclosed technology relates to an efficient deep model to stabilize the depth prediction in AR/MR applications. Traditional deep models are too complex to be deployed in mobile devices. The disclosed solution uses an efficient deep model to stabilize the depth prediction in AR/MR applications. The disclosed model is the smallest depth stabilization model that can fit into a mobile AR/MR headset and achieve significant results. The depth stabilization network is a key component in AR/MR applications. The new network structure used in this model is also general and can be used in other computer vision models.

To stabilize depth, the disclosed solution combines the current depth estimation and the previous history. The fusion procedure is done carefully because the motion compensation from simultaneous localization and mapping (SLAM) does not work for dynamic objects. To address this problem, the disclosed model automatically segments the scene into dynamic and static parts so the proposed model can work for complex dynamic scenes. The key is that a very small network is to build and make sure it still can achieve the desired result. The subject solution proposes a new Shuffle-fully convolution network (FCN) structure. It reduces the input resolution by pixel-unshuffling before going through a fully convolution network and in the end the result is shuffled back. This not only makes the network many times faster but also enables using a small convolution kernel to achieve a large receptive field. The disclosed solution also uses the shuffle scheme to speed up other pixel level operations in the network.

Compared to existing depth stabilization deep models, the proposed model is the smallest and it can achieve results as good as or even better than the large models. The recurrent network can also be extended to improve the temporal consistency of other entities such as semantic segmentation.

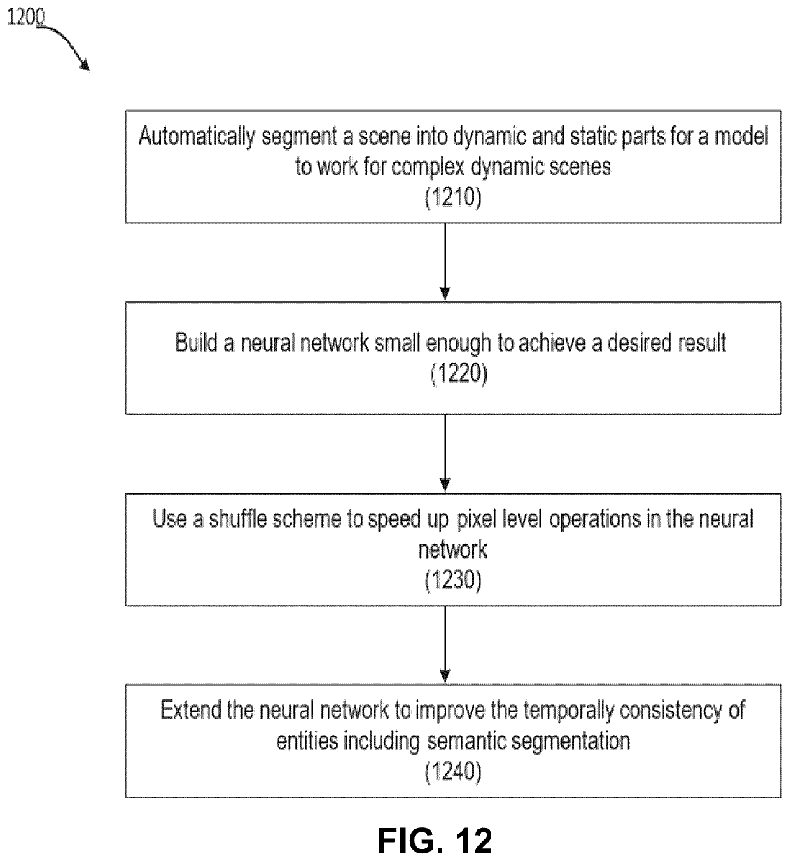

Turning now to the figures, FIG. 12 is a flow diagram illustrating a process 1200 for implementing an efficient depth stabilizer for MR and AR, according to some aspects of the subject technology. The process 1200 includes process steps 1210, 1220, 1230 and 1240.

In the process step 1210, a neural network model of the subject technology automatically segments (e.g., by a processor) the scene into dynamic and static parts so the model can work for complex dynamic scenes.

In the process step 1220, a neural network that is small enough to achieve the desired goal is built. The disclosed solution uses a new shuffle-FCN structure, which reduces the input resolution by pixel-unshuffling before going through a fully convolution network and in the end the result is shuffled back. This not only makes the network many times faster but also enables using a small convolution kernel to achieve a large receptive field.

In the process step 1230, the shuffle scheme (e.g., shuffle-FCN) is used to speed up other pixel level operations in the neural network. Compared to existing depth stabilization deep models, the disclosed model is the smallest and it can achieve results as good as or even better than the large models.

In the process step 1240, the recurrent network is extended to improve the temporal consistency of other entities such as semantic segmentation.

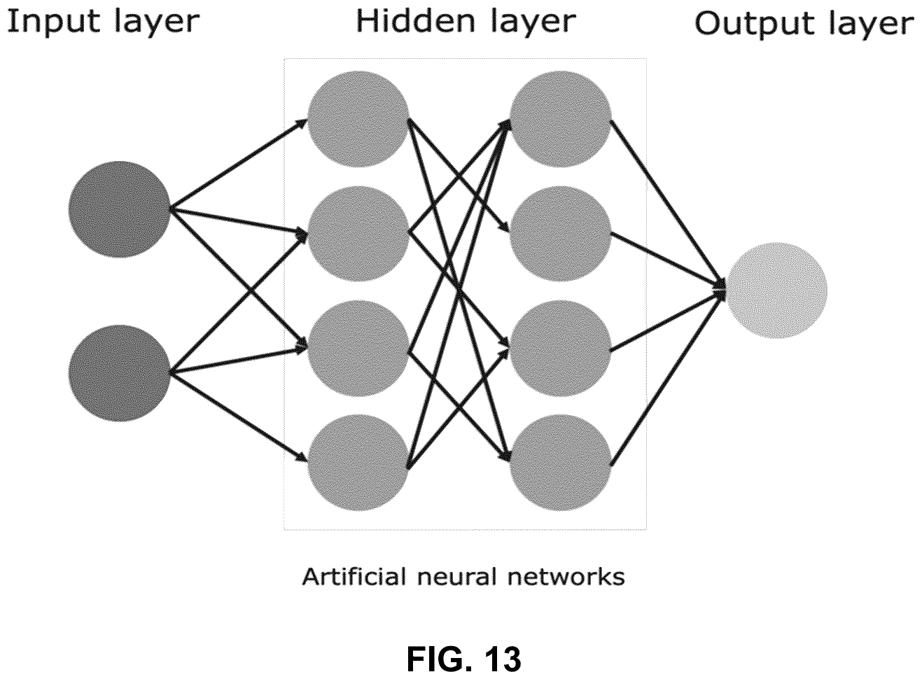

FIG. 13 is a high-level block diagram illustrating a neural network architecture within which some aspects of the subject technology are implemented. Neural networks mimic the human brain with interconnected nodes, called neurons, organized in layers. The basic architecture comprises an input layer receiving information, at least one hidden layer processing it, and an output layer presenting the final result. Each neuron receives signals from connected neurons, processes them using mathematical operations, and sends the output to others. The connections have weights that adjust during learning to influence the impact of different inputs. The network's complexity depends on the task, with the arrangement of nodes, connection patterns, and activation functions defining its architecture. This architecture determines how the network learns from data and makes predictions, playing a crucial role in its ability to perform tasks like image recognition, speech translation, and natural language processing.

A neural network's architecture, or map of its neural layers and processes, and its model together determine how the network turns input into output. The architecture is the backbone that enables the model to understand and process various data types. The model uses the architecture to build an abstract understanding of the data and perform complex tasks.

The subject technology uses a shuffle-FCN structure, as described above to reduce the input resolution by pixel-unshuffling before going through a fully convolution network and in the end the result is shuffled back. This not only makes the network many times faster but also enables using a small convolution kernel to achieve a large receptive field.

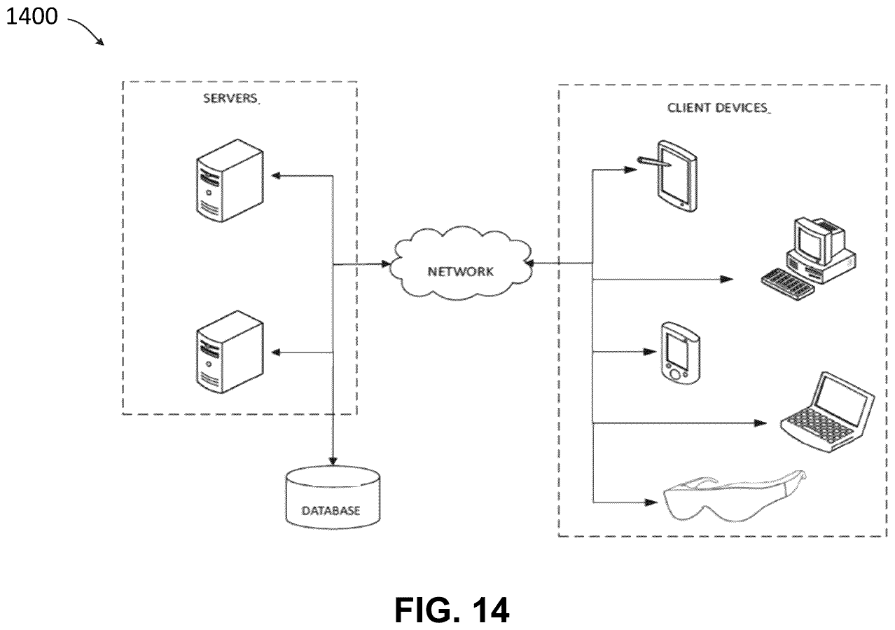

FIG. 14 is a high-level block diagram illustrating a network architecture within which some aspects of the subject technology are implemented. The network architecture 1400 may include servers and a database, communicatively coupled with multiple client devices via a network. Client devices may include, but are not limited to, laptop computers, desktop computers, and the like, and/or mobile devices such as smart phones, palm devices, video players, headsets, tablet devices, and the like.

The network may include, for example, any one or more of a local area network (LAN), a wide area network (WAN), the Internet, and the like. Further, the network may include, but is not limited to, any one or more of the following network topologies, including a bus network, a star network, a ring network, a mesh network, a star-bus network, tree or hierarchical network, and the like.

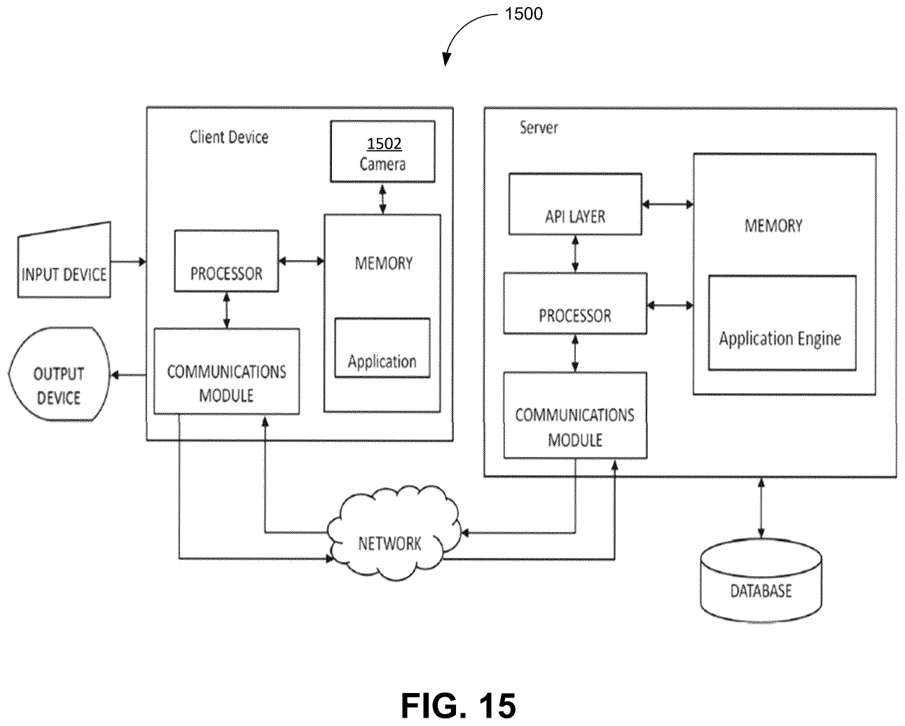

FIG. 15 is a block diagram illustrating details of a system including a client device and a server, as discussed herein. The system 1500 includes at least one client device, at least one server of the network architecture discussed above, a database and the network. The client device and the server are communicatively coupled over the network via respective communications modules (hereinafter, collectively referred to as “communications modules”). Communications modules are configured to interface with the network to send and receive information, such as requests, uploads, messages, and commands to other devices on the network. Communications modules can be, for example, modems or Ethernet cards, and may include radio hardware and software for wireless communications (e.g., via electromagnetic radiation, such as radiofrequency (RF), near field communications (NFC), Wi-Fi, and Bluetooth radio technology).

The client device may be coupled with an input device and with an output device. A user may interact with the client device via the input device and the output device. The input device may include a mouse, a keyboard, a pointer, a touchscreen, a microphone, a joystick, a virtual joystick, a touchscreen display that a user may use to interact with the client device, or the like. In some embodiments, the input device may include cameras, microphones, and sensors, such as touch sensors, acoustic sensors, inertial motion units and other sensors configured to provide input data to a VR/AR headset. The output device may be a screen display, a touchscreen, a speaker, and the like.

The client device may also include an MR/AR headset, a processor, a memory and the communications module. The MR/AR headset is in communication with the processor and the memory. The processor is configured to execute instructions stored in a memory, and to cause the client device to perform at least some operations in methods consistent with the present disclosure. The memory may further include an application, configured to run in the client device and couple with the input device, the output device and the camera 1502. The application may be downloaded by the user from the server, and/or may be hosted by the server. The application includes specific instructions which, when executed by the processor, cause operations to be performed according to methods described herein. In some embodiments, the application runs on an operating system (OS) installed in the client device. In some embodiments, the application may run within a web browser. In some embodiments, the processor is configured to control a graphical user interface (GUI) for the user of one of the client devices accessing the server.

In some embodiments, the MR/AR headset is the device for which the subject technology provides an efficient depth stabilizer, as described above.

The database may store data and files associated with the server from the application. In some embodiments, the client device collects data, including but not limited to video and images, for upload to the server using the application, to store in the database.

The server includes a memory, a processor, an application program interface (API) layer and a communications module. Hereinafter, the processors and memories will be collectively referred to, respectively, as “processors” and “memories.” The processors are configured to execute instructions stored in memories. In some embodiments, the memory includes an application engine. The application engine may be configured to perform operations and methods according to aspects of embodiments. The application engine may share or provide features and resources with the client device, including multiple tools associated with data, image, video collection, capture, or applications that use data, images, or video retrieved with the application engine (e.g., the application). The user may access the application engine through the application, installed in a memory of the client device. Accordingly, the application may be installed by the server and perform scripts and other routines provided by server through any one of multiple tools. Execution of the application may be controlled by processor.

The application used by the client device includes several application modules including, but not limited to, an AI module. The AI module may include a number of AI models. AI models apply different algorithms to relevant data inputs to achieve the tasks, or an output for which the model has been programmed for. An AI model can be defined by its ability to autonomously make decisions or predictions, rather than simulate human intelligence. Different types of AI models are better suited for specific tasks, or domains, for which their decision-making logic is most useful or relevant. Complex systems often employ multiple models simultaneously, using ensemble learning techniques like bagging, boosting or stacking.

AI models can automate decision-making, but only models capable of machine learning (ML) are able to autonomously optimize their performance over time. While all ML models are AI, not all AI involves ML. The most elementary AI models are a series of if-then-else statements, with rules programmed explicitly by a data scientist. Machine learning models use statistical AI rather than symbolic AI. Whereas rule-based AI models must be explicitly programmed, ML models are trained by applying their mathematical frameworks to a sample dataset whose data points serve as the basis for the model's future real-world predictions.

Clause 1: A method of the subject technology includes using a neural network to simulate a model to stabilize depth of an MR and/or AR headset.

In an aspect, the method includes combining a current depth estimation and a previous history.

In an aspect, the model automatically segments the scene into dynamic and static parts to allow the model to work for complex dynamic scenes.

In an aspect, the model is small enough to achieve a desired result.

In an aspect, the neural network comprises a shuffle-FCN network structure.

In an aspect, the method reduces an input resolution by pixel-unshuffling before going through a fully convolution network and finally shuffles back the result to make the network many times faster and to enable using a small convolution kernel to achieve a large receptive field.

In an aspect, the method uses the shuffle scheme to speed up other pixel level operations in the neural network.

In an aspect, the method extends a recurrent network to improve temporal consistency of other entities including a semantic segmentation.

### Alternative Embodiments

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out or conducted in various ways. Examples of specific implementations are provided herein for illustrative purposes only and are not intended to be limiting. In particular, acts, elements and features described in connection with any one or more examples are not intended to be excluded from a similar role in any other examples.

It is to be understood that the methods and systems described herein are not limited to specific methods, specific components, or to particular implementations. It is also to be understood that the terminology used herein is for the purpose of describing particular examples only and is not intended to be limiting.

As used herein, the terms “data,” “content,” “information” and similar terms may be used interchangeably to refer to data capable of being transmitted, received and/or stored in accordance with examples of the disclosure. Moreover, the term “exemplary”, as used herein, is not provided to convey any qualitative assessment, but instead merely to convey an illustration of an example. Thus, use of any such terms should not be taken to limit the spirit and scope of examples of the disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, “artificial reality” may refer to a form of immersive reality that has been adjusted in some manner before presentation to a user, which may include, for example, a virtual reality, an augmented reality, a mixed reality, a hybrid reality, Metaverse reality or some combination or derivative thereof. Artificial reality content may include completely computer-generated content or computer-generated content combined with captured (e.g., real-world) content. In some instances, artificial reality may be associated with applications, products, accessories, services, or some combination thereof, that may be used to, for example, create content in an artificial reality or are otherwise used in (e.g., to perform activities in) an artificial reality.

As referred to herein, “artificial reality content” may refer to content such as video, audio, haptic feedback, or some combination thereof, any of which may be presented in a single channel or in multiple channels (such as stereo video that produces a three-dimensional (3D) effect to the viewer) to a user.

As referred to herein, a Metaverse may denote an immersive virtual/augmented reality world in which augmented reality (AR) devices may be utilized in a network (e.g., a Metaverse network) in which there may, but need not, be one or more social connections among users in the network. The Metaverse network may be associated with three-dimensional (3D) virtual worlds, online games (e.g., video games), one or more content items such as, for example, non-fungible tokens (NFTs) and in which the content items may, for example, be purchased with digital currencies (e.g., cryptocurrencies) and other suitable currencies.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

The scope of this disclosure encompasses all changes, substitutions, variations, alterations, and modifications to the example examples described or illustrated herein that a person having ordinary skill in the art would comprehend. The scope of this disclosure is not limited to the example examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

This written description uses examples to enable any person skilled in the art to practice the claimed subject matter, including making and using any devices or systems and performing any incorporated methods. Other variations of the examples are contemplated herein. It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

The scope of this disclosure encompasses all changes, substitutions, variations, alterations, and modifications to the example embodiments described or illustrated herein that a person having ordinary skill in the art would comprehend. The scope of this disclosure is not limited to the examples described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

What is claimed:

1. A method comprising:
receiving, via a device, an indication of an input;
determining an association between one or more embedded data and the input, via a trained machine learning model, wherein the trained machine learning model is trained on data associated with a user profile, one or more connections to the user profile, or any combination thereof;
generating, via the trained machine learning model, one or more content items, based on the association; and
transmitting a result to the device.

2. The method of claim 1, wherein the trained machine learning model utilizes a retrieval generator to determine the result.

3. The method of claim 2, wherein the retrieval generator is configured to use an applications native search function in response to the input.

4. The method of claim 1, wherein the input may be any one or more of audio, text, an image, or any other suitable input.

5. The method of claim 1, wherein the trained machine learning model may determine a context and an interest associated with a combination of the input and the user profile.

6. The method of claim 1, wherein the one or more connections to the user profile comprises relationships to one or more other users associated with one or more other user profiles.

7. The method of claim 1, wherein one or more connections to the user profile comprises a first friend of a plurality of friends associated with a list of friends.

8. The method of claim 7, wherein the list of friends may be indicated by the user profile.

9. The method of claim 3, wherein the applications native search function is configured to fetch data from a database associated with the user profile and one or more connections to the user profile.

10. A method for video editing, comprising:
receiving an input video and an editing instruction;
generating an edited video using a student model, wherein the student model comprises:
a text-to-image backbone;
an image editing adapter attached to the text-to-image backbone;
a video generation adapter attached to the text-to-image backbone; and
alignment parameters for aligning the image editing adapter and video generation adapter;
applying a score distillation sampling loss using a frozen image editing teacher model;
applying a score distillation sampling loss using a frozen video generation teacher model;
applying an adversarial loss using an image editing discriminator;
applying an adversarial loss using a video generation discriminator; and
updating the alignment parameters based on the score distillation sampling loss using the frozen image editing teacher model, the score distillation sampling loss using the frozen video generation teacher model, the adversarial loss using the image editing discriminator, and the adversarial loss using the video generation discriminator.

11. The method of claim 10, wherein the image editing adapter is trained to edit individual frames and the video generation adapter is trained to generate temporally consistent video frames.

12. The method of claim 10, wherein the student model is trained with unsupervised data.

13. The method of claim 10, wherein the image editing discriminator or the video generation discriminator attempt to differentiate between samples generated by the video generation teacher model and image editing teacher model and samples generated by the student model.

14. The method of claim 10, wherein the alignment parameters comprise low-rank adaptation weights.

15. The method of claim 10, further comprising:
dividing diffusion timesteps into bins; and
randomly selecting timesteps from the bins for training the student model.

16. An apparatus for video editing, comprising:
a processor; and
a memory storing instructions that, when executed by the processor, cause the apparatus to:
receive an input video and an editing instruction;
generate, based on the editing instructions, an edited video associated with the input video using a student model comprising aligned image editing and video generation adapters;
apply score distillation sampling losses using frozen image editing and video generation teacher models;
apply adversarial losses using image editing and video generation discriminators; and
update alignment parameters of the student model based on the applied score distillation sampling losses or the adversarial losses.

17. The apparatus of claim 16, wherein the student model comprises a text-to-image backbone with the image editing and video generation adapters attached.

18. The apparatus of claim 16, wherein the alignment parameters comprise low-rank adaptation weights for aligning the image editing and video generation adapters.

19. The apparatus of claim 16, wherein the instructions further cause the apparatus to:
divide diffusion timesteps into bins; and
randomly select timesteps from the bins for training the student model.

20. The apparatus of claim 16, wherein the instructions further cause the apparatus to:
determine the adversarial losses by discriminators attempting to differentiate between samples generated by the teacher models and the student model.
